(19) United States
(12) Patent Application Publication
(10) Pub. No.: US 2015/0305081 A1
(43) Pub. Date: Oct. 22, 2015

(54) A Method and Apparatus for Controlling Association Between a Station and a WLAN

(71) Applicant: TELEFONAKTIEBOLAGET L M ERICSSON (PUBL), Stockholm (SE)

(72) Inventors: Tomas Hedberg, Stockholm (SE); Jari Vikberg, Järna (SE); Oscar Zee, Stockholm (SE)

(21) Appl. No.: 14/440,904

(22) PCT Filed: Nov. 22, 2012
(86) PCT No.: PCT/EP2012/073361

§ 371 Date: May 6, 2015

(51) Int. Cl. H04W 76/02; H04W 24/10; H04W 84/12

(52) U.S. Cl. CPC H04W 76/027; H04W 84/12; H04W 76/021; H04W 24/10

(57) ABSTRACT

The invention provides a method of operating an entity in a wireless local area network, WLAN. In the method, upon determining that a device has been denied an association with or disassociated from the WLAN, the entity causes a WLAN identifier associated with the device to be stored in a database, an entry in the database indicating that the entity should not associate with the STA associated with the WLAN identifier, the WLAN identifier being stored in association with a condition such that when the condition is met the corresponding WLAN identifier is removed from the database.

### TECHNICAL FIELD

The present invention relates to a method and apparatus for controlling the association between a station and a WLAN and more particularly, for controlling the association between a station and a WLAN access point.

### BACKGROUND

Data traffic in mobile telecommunications networks is continually increasing. Consequently, operators are employing heterogeneous access networks that utilise multiple radio access technologies (RATs) in order to provide greater capacity, particularly in high traffic areas and areas that otherwise have poor network coverage.

Typically, the radio access technologies utilised as part of these heterogeneous access networks include UMTS Radio Access Network (UTRAN) and an Evolved UTRAN (E-UTRAN), and Wi-Fi/WLAN. For example, FIG. 1 illustrates schematically a simplified example of a heterogeneous network 1 that comprises a 3GPP network 2 and a Wi-Fi/WLAN 3 suitable for implementing the methods described herein.

The 3GPP network 2 may include a 3GPP Radio Access Network (RAN) which includes a number of 3GPP radio nodes 4. For example, if the 3GPP RAN was a UTRAN, then these radio nodes would be NodeBs and Radio Network Controllers (RNC). By way of further example, if the 3GPP RAN was an E-UTRAN, then these radio nodes would be eNode Bs. The 3GPP RAN 2 is connected to a mobile core network 5.

The WLAN 3 includes a number of WLAN APs 7 that may be connected to a WLAN Access Controller (AC) 8. If present the WLAN AC 8 can control each of the WLAN APs 7 and assists in authentication of a mobile station/user terminal that wants to associate with/attach to the WLAN 3. Within the WLAN a single AP and any mobile stations/user terminals associated with it is called a basic service set (BSS). A BSS is identified using a basic service set identification (BSSID) which may be the AP's MAC address. Interconnected BSSs and/or integrated WLANs may appear as a single BSS to the logical link control layer. The interconnected BSSs and/or integrated WLANs are called an extended service set (ESS) and have a common service set identifier (SSID).

If the heterogeneous access network comprises a UTRAN, an E-UTRAN, and a Wi-Fi RAN/WLAN then both the UTRAN and E-UTRAN standards are defined by the 3rd Generation Partnership Project (3GPP), and the relevant 3GPP standards therefore define capabilities for handling load sharing between these 3GPP RANs. In contrast, the standards governing Wi-Fi/WLAN are defined by the Institute of Electrical and Electronics Engineers (IEEE) and potentially also the WiFi Alliance (WFA), and neither the IEEE standards, WFA standards nor the 3GPP standards define capabilities for handling load sharing between Wi-Fi/WLAN and the 3GPP RANs.

In particular, for most currently available devices, i.e. stations (STA) or a client device, when the device is within the coverage of both a Wi-Fi RAN/WLAN and a 3GPP network, the device will automatically attempt to connect to the Wi-Fi RAN/WLAN and will detach from (or refrain from sending data via) the 3GPP RAN.

STAs always initiate the association process and a WLAN AP may choose to grant or deny the association based upon the contents of an association request. In a WLAN network operating according to the 802.11 standard (Wi-Fi) the WLAN AP will periodically transmit a Beacon frame which contains all of the information about the WLAN including, for example, the SSID for the AP.

An example of a method of associating a STA and a Wi-Fi AP is illustrated in FIG. 2. As described above the Wi-Fi AP periodically transmits a Beacon frame. When a STA attempts to associate with the WLAN identified in the Beacon frame it will transmit a Probe Request requesting information from the Wi-Fi AP. An AP, upon receiving a probe request will reply with a Probe Response message including station parameters. The station parameters may include, for example, capability information and supported data rates.

In order to associate with the Wi-Fi AP the STA must be authenticated. The STA therefore transmits an Authentication Request then request authentication which may take place using any suitable authentication scheme. Once authentication has occurred the Wi-Fi AP transmits the STA an Authentication Response message and the STA, upon receiving such a response message may send an Association Request to the Wi-Fi AP. The Wi-Fi AP transmits a response to the Association Request indicating whether the association is accepted or rejected.

Optionally, where the WLAN is not open, further authentication is required over that described above. Where further authentication such as that defined in the EAP-SIM/AKA/AKA’ protocol, is required then the Authentication Request only opens limited ports to enable the further authentication to take place. Full association is only granted upon successful completion of the further authentication.

An alternative standard which may govern communications between a WLAN AP and the STA is HotSpot 2.0. HotSpot 2.0 builds on IEEE 802.11u, and adds requirements on authentication mechanisms and auto-provisioning support. HotSpot 2.0 uses the Access network Query Protocol (ANQP) as illustrated in FIG. 3. In HotSpot 2.0 the ANQP provides a mechanism for the STA to request different information from the AP before association occurs.

At any point in the association procedures described above the WLAN AP may reject the access attempt, although rejection at particular points in the procedure is preferred, since the STA behaviour will be well-defined at these points. It is preferable to reject an association request from a STA as soon as possible in order to limit the resources that the WLAN devotes to processing requests from the STA. However, as only a temporary identifier, such as the MAC address associated with the STA is known to the WLAN rather than a permanent identifier (such as the IMSI related to the (U)SIM module on the STA) can be difficult to reject an association request early in the procedure. This results in an unnecessary load on the WLAN AP in terms of air interface signalling and also processing capacity.

Additionally, some STAs will continuously try to re-associate and re-authenticate to the same WLAN AP even if the WLAN AP has previously rejected an association attempt by the STA, for example, by rejecting authorization. This will increase the load on the WLAN AP even further.

### SUMMARY

According to an aspect of the present invention there is provided a method of operating an entity in a wireless local area network, WLAN. The method includes causing a WLAN identifier associated with the device to be stored in a database upon determining that a device has been denied an association with or disassociated from the WLAN. An entry in the database indicates that the entity should not associate with the device associated with the WLAN identifier, the WLAN identifier being stored in association with a condition such that when the condition is met the corresponding WLAN identifier is removed from the database. By entering WLAN identifiers into a database in this way the entity in the WLAN is provided with a database that it can refer to in order to quickly determine whether the a request from an STA to associate with the WLAN should be responded to or not.

The method of operating the entity in the wireless local area network method may also include receiving a message from a device, the message including a WLAN identifier associated with the device. When the message is received the method includes determining whether the WLAN identifier is stored in the database and, if the WLAN identifier is stored in the database, not responding to the message or, if the WLAN identifier is not stored in the database, responding to the message.

Causing the WLAN identifier to be stored in a database may include causing the WLAN identifier to be stored in a database in a memory in the entity in the WLAN or transmitting the WLAN identifier to another entity in the WLAN and causing the WLAN identifier to be stored in a database in a memory of the another entity. If the WLAN identifier is stored in another entity in the WLAN it may be stored, for example in an Access Controller (AC). Where the WLAN identifier is stored in another entity such as an AC it enables that AC to quickly deny authentication for any STAs which have been denied an association by another WLAN AP in an ESS.

The condition may be a time value and the method may include removing the WLAN identifier from the database once the time value has expired. The time value may be determined according to a measured RSSI value of the UE during the first association attempt, determined according to the AP cell load and/or the load of 3GPP cells which overlap with the AP's area of coverage.

The speed that the time value is counted down may be a predetermined speed. Alternatively, the speed that the time value is counted down may be dependent upon one or more of, the measured RSSI value of the STA, the load in the WLAN, the load on the entity of the WLAN, the load on 3GPP cells which overlap with the area of the coverage of the entity.

The WLAN identifier may be, for example, a MAC address.

According to another aspect of the present invention there is provided an entity in a wireless local area network, WLAN. The entity causes a WLAN identifier associated with the device to be stored in a database, upon determining that a device has been denied an association with or disassociated from the WLAN. An entry in the database indicates that the entity should not allow an association with the STA, the WLAN identifier being stored in association with a condition such that when the condition is met the corresponding WLAN identifier is removed from the database.

The entity may also include a receiver to receive a message from a device, the message comprising a WLAN identifier associated with the device and a processor to determine whether the WLAN identifier is stored in the database. The processor is operable to, if the WLAN identifier is stored in the database, cause the entity not to respond to the message and, if the WLAN identifier is not stored in the database, to cause the entity to respond to the message.

The entity may also include a memory to store the database. The entity is operable to cause the WLAN identifier for the device to be stored in a database in the memory.

The entity may also include transmitter. The entity being operable to cause a WLAN identifier associated with the device transmitted to another entity in the WLAN.

The condition may be comprises a time value wherein once the time value has expired the WLAN identifier is removed from the d.

The condition may be a time value and the method may include removing the WLAN identifier from the database once the time value has expired. The time value may be determined according to a measured RSSI value of the UE during the first association attempt, determined according to the AP cell load and/or the load of 3GPP cells which overlap with the AP's area of coverage.

The speed that the time value is counted down may be a predetermined speed. Alternatively, the speed that the time value is counted down may be dependent upon one or more of, the measured RSSI value of the STA, the load in the WLAN, the load on the entity of the WLAN, the load on 3GPP cells which overlap with the area of the coverage of the entity.

The WLAN identifier may be, for example, a MAC address.

### BRIEF DESCRIPTION OF THE DRAWINGS

Some embodiments of the present invention will now be described in detail with reference to the accompanying drawings, in which:

FIG. 1 illustrates schematically an example of a heterogeneous access network;

FIG. 2 is a signalling flow diagram illustrating an example of a procedure for associating a STA with a Wi-Fi AP;

FIG. 3 is a signalling flow diagram illustrating an example of an alternative procedure for associating a STA with a Wi-Fi AP;

FIG. 4 illustrates schematically an embodiment of a WLAN entity configured to implement the methods described herein; and

FIG. 5 is a flow diagram illustrating a procedure for controlling the association of a STA with a WLAN AP in accordance with the methods described herein.

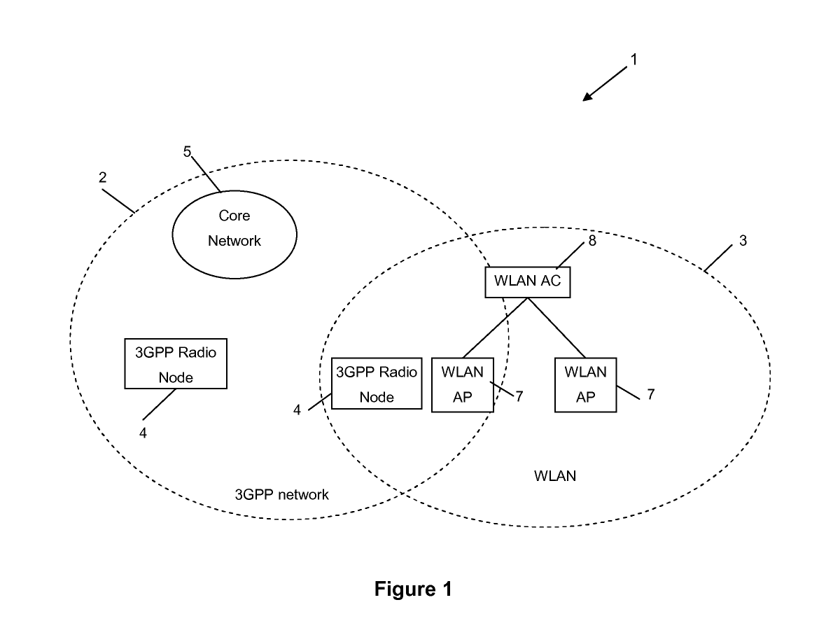

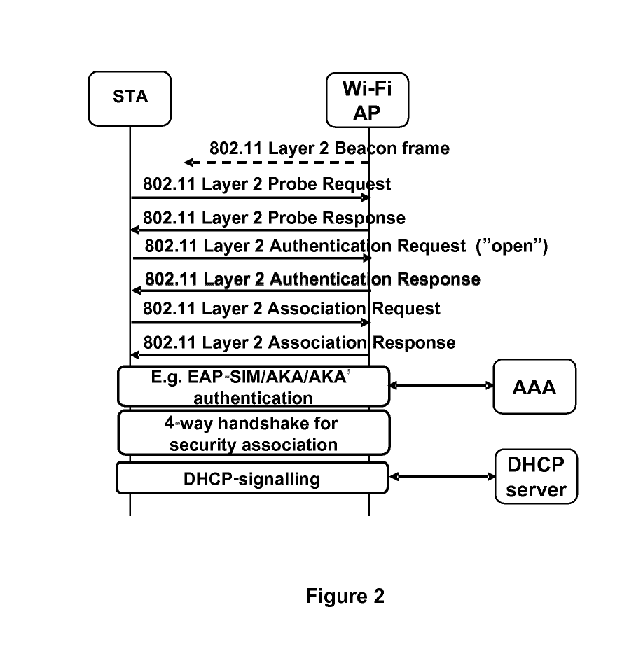

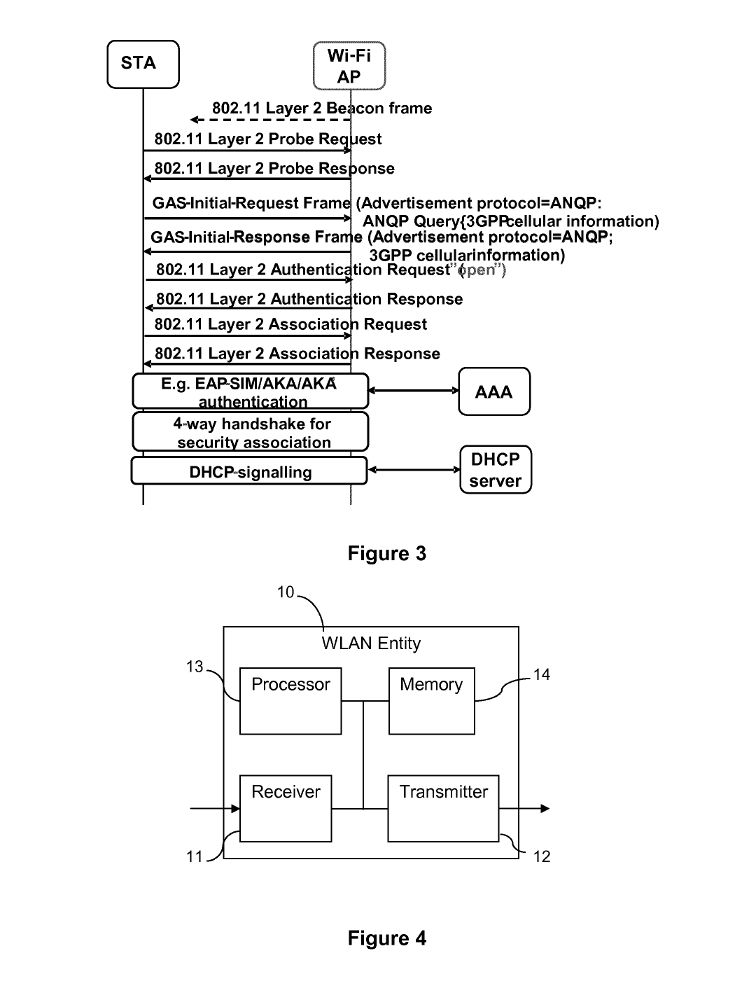

### DETAILED DESCRIPTION

In order to at least mitigate the problems identified above there will now be described a method of operating a WLAN AP to control the association of a STA with the WLAN AP.

FIG. 4 illustrates schematically an embodiment of a WLAN entity 10 configured to implement the methods described above. The WLAN entity 10 can be implemented as a combination of computer hardware and software and comprises a receiver 11, transmitter 12, a processor 13, and a memory 14. The memory 14 stores the various programs/executable files that are implemented by the processor 13, and also provides a storage unit for any required data.

The storage unit in the memory 14 of the WLAN entity 10 is configured to store a MAC address for at least one STA. The programs/executable files stored in the memory 14, and implemented by the processor, include but are not limited to a MAC storage unit configured to cause a MAC address to be stored in the memory 14 in accordance with the methods described below; a MAC address manager configured to manage the MAC addresses stored in the memory 14 in accordance with the methods described below; and a MAC address retrieval unit, and an information retrieval unit configured to implement the methods described below.

The WLAN entity may be, for example, a WLAN AP or a WLAN AC.

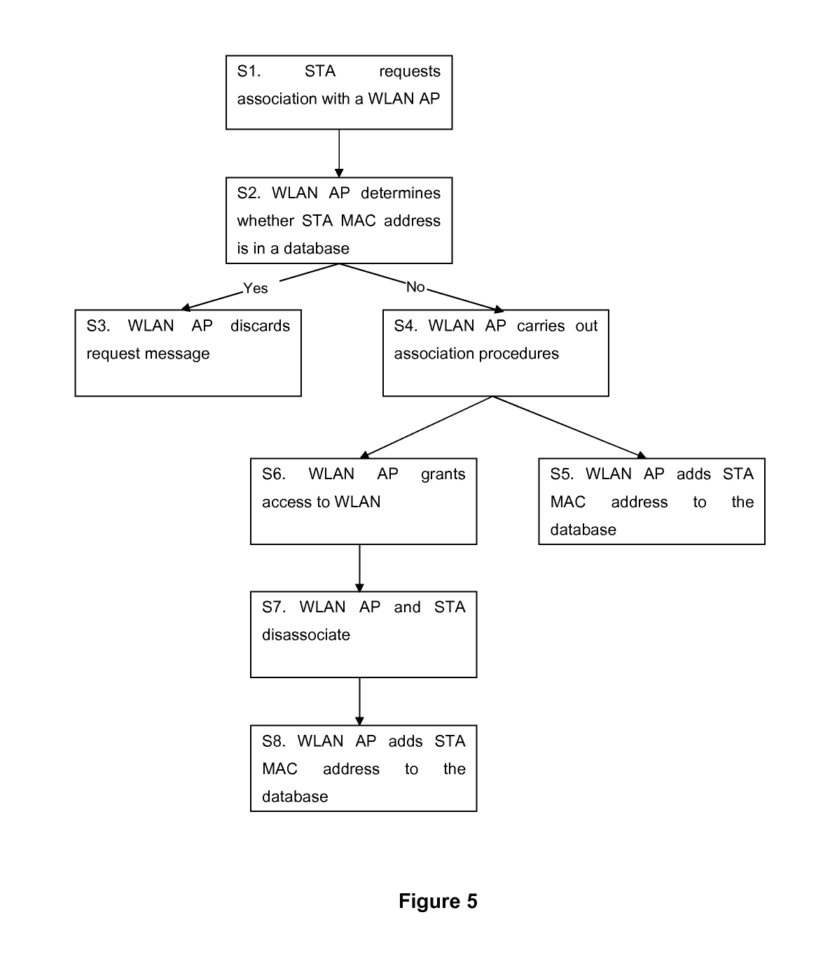

FIG. 5 is a flow diagram illustrating an example of the procedure implemented by a WLAN AP having a memory including one or more MAC addresses operating according to the IEEE 802.11 Standard. The steps performed are as follows:

S1. An STA operating according to the IEEE 802.11 Standard requests an association with a WLAN AP by transmitting an 802.11 Layer 2 Probe Request to a WLAN AP. Such a Probe Request will include the STA's MAC address.

S2. The WLAN AP determines whether the MAC address included in the Probe Request is included in a database of MAC addresses in its memory.

S3. If the MAC address is included in the database of MAC addresses then the WLAN AP does not respond to the Probe Request and takes no further action.

S4. If the MAC address is not included in the database then the WLAN AP transmits an 802.11 Layer 2 Probe Response and association of the STA and the WLAN AP proceeds according to the IEEE 802.11 Standard.

S5. If at any point during the association procedure the WLAN AP determines to refuse an association with the STA the WLAN AP will terminate the association procedure using the method defined in the IEEE 802.11 Standard. At the same time as terminating the association procedure the WLAN AP will add the MAC address for the STA to its memory to the database of MAC addresses. This means that in the event the STA subsequently sends a Probe Request to the WLAN AP the WLAN AP will automatically not respond to this message as described with reference to steps S1. to S3.

S6. If the WLAN AP does not determine to refuse an association with the STA then the WLAN AP and the STA will become associated.

S7. The association between the WLAN AP and STA may be terminated at any time, for example if the WLAN AP deauthenticates the STA or the STA requests disassociation from the WLAN AP. By including the MAC address for a STA that has requested disassociation a time limit may be imposed on how soon the STA can request reassociation with the WLAN AP.

S8. When the session between the WLAN AP and STA terminates the WLAN AP stores the MAC address for the STA to its memory to the database of MAC addresses. This means that in the event the STA continues to contact the WLAN AP the WLAN AP will automatically discard any further messages from the STA as described with reference to steps S1. to S3.

Optionally, the WLAN AP may not store the MAC address when it disassociates from the WLAN AP but only when the STA is deauthenticated. This will allow a STA to reassociate with the WLAN AP when required.

The WLAN AP may store the MAC address of a STA in association with a counter or timestamp which indicates the time at which the MAC address is to be removed from the memory. The time may, for example, be a time to live value, which decreases until it reaches 0 at which point the MAC address associated with the counter is removed from the memory.

The time to live value may be calculated using any suitable method. For example, the time to live value may be a predefined value for that WLAN AP or any WLAN AP in an ESS. Alternatively, the time to live value may be related to a property of the STA when it transmits the Probe Request which resulted in the MAC address being entered into the memory. For example, the STA property may be a measured received signal strength indicator (RSSI) value for the STA where the greater the RSSI value the smaller the time to live value. Alternatively, the STA property may be that the STA requested disassociation from the WLAN AP or was deauthenticated. Another way of determining the time to live value is using a property of the WLAN AP. For example, the WLAN AP property may be the cell load when the WLAN AP receives the Probe Request from the STA where the greater the AP cell load the greater the time to live value. A further way of determining the time to live value may be to use a property of any neighbouring or overlapping 3GPP cells. For example, the property may be the load in one or more overlapping or neighbouring 3GPP cells where the smaller the load the greater the time to live value. The WLAN may obtain details of the load of neighbouring 3GPP cells using the method described in PCT/EP2012/065970.

The time to live value may be calculated using any one of the aforementioned factors or alternatively, any combination of these factors may be used along with any other factors that the WLAN operator deems relevant. The relationship between the time to live value and the property(s) may be any suitable relationship. For example, the time to live value may be proportional to the property value.

In addition to or instead of determining different time to live values for different instances specific to the STA the WLAN AP may vary the speed of the counter used to count down the time to live value. Thus, although the counter may count down the time to live value at a predetermined speed the counter speed may vary. The counter speed may be varied, for example, according to the measured RSSI value for the STA when the Probe Request was received (the greater the RSSI value the faster the clock will count down), whether the STA requested disassociation from the WLAN AP, whether the STA was deauthenticated, according to the load on the WLAN or the WLAN AP (the greater the load the slower the clock will count down) or according to the load on neighbouring 3GPP cells (the lower the load the slower the clock will count down). The counter speed may be varied for each STA individually or for a plurality of STAs according to the property used to determine the rate that the time to live value is counted down.

The counter speed may be calculated using any one of the aforementioned factors or alternatively, any combination of these factors may be used along with any other factors that the WLAN operator deems relevant. The relationship between the time to live value and the property(s) may be any suitable relationship. For example, the time to live value may be proportional to the property value.

The skilled person will understand that the MAC addresses and associated data, such as a time to live value, may be stored in a database, list or any other suitable data structure. Additionally, the MAC addresses and associated data may not be stored in the memory of the WLAN AP but rather may be stored in the WLAN AC. Alternatively the MAC addresses and associated data may be stored in both the WLAN AP and the WLAN AC. This allows the WLAN AC to quickly deny authentication for any STAs which have been denied an association by another WLAN AP in an ESS.

Although the present invention has been described with reference to the IEEE 802.11 Standard, the skilled person will understand how the methods described above may be applied to any Standard used to govern a WLAN and WLAN APs.

By 3GPP RAN or network what is meant is any RAN or network which is governed by 3GPP Standards. For example, a 3GPP network may be a UTRAN, an E-UTRAN or a Long Term Evolution (LTE) network. WLAN may refer to any wireless local area network including, but not limited to a Wi-Fi RAN.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. In addition, whilst the above described embodiments specifically relate to heterogeneous networks comprised of at least a 3GPP RAN and a WLAN, the principles of the methods described herein are equally applicable to heterogeneous networks that comprise other radio access technologies; such as Global System for Mobile Communications (GSM), cdmaOne and CDMA2000.

1-18. (canceled)

19. A method of operating an entity in a wireless local area network (WLAN), the method comprising:
in response to determining that a device has been denied an association with, or disassociated from, the WLAN, causing a WLAN identifier associated with the device to be stored in a database, an entry in the database indicating that the entity should not associate with the device associated with the WLAN identifier;
wherein the WLAN identifier is stored in association with a condition such that when the condition is met the corresponding WLAN identifier is removed from the database.

20. The method of claim 19, further comprising:
receiving a message from a device, the message comprising a WLAN identifier associated with the device;
determining whether the WLAN identifier is stored in the database;
if the WLAN identifier is stored in the database, not responding to the message; and
if the WLAN identifier is not stored in the database, responding to the message.

21. The method of claim 19, wherein the entity further comprises a memory configured to store the database.

22. The method of claim 19, wherein causing a WLAN identifier associated with the device to be stored in a database comprises transmitting the WLAN identifier to another entity in the WLAN, the other entity in the WLAN comprising a memory including the database.

23. The method of claim 19, wherein the condition comprises a time value, wherein once the time value has expired the WLAN identifier is removed from the database.

24. The method of claim 23, wherein a speed that the time value is counted down is a predetermined speed.

25. The method of claim 23, wherein the time value is determined according to at least one of:
a measured Received Signal Strength Indicator (RSSI) value of the device during the first association attempt;
an Access Point (AP) cell load;
a load of 3GPP cells which overlap with the AP's area of coverage.

26. The method of claim 25, wherein a speed that the time value is counted down is dependent upon at least one of:
the measured RSSI value of the device;
a load in the WLAN;
a load on the entity of the WLAN;
the load of 3GPP cells which overlap with the area of the coverage of the entity.

27. The method of claim 19, wherein the WLAN identifier is a MAC address.

28. An entity in a wireless local area network (WLAN), the entity comprising:
one or more processing circuits configured to cause the entity to:
in response to determining that a device has been denied an association with, or disassociated from, the WLAN, cause a WLAN identifier associated with the device to be stored in a database, an entry in the database indicating that the entity should not allow an association with the STA;
wherein the WLAN identifier is stored in association with a condition such that when the condition is met the corresponding WLAN identifier is removed from the database.

29. The entity of claim 28:
further comprising a receiver configured to receive a message from a device, the message comprising a WLAN identifier associated with the device;
wherein the processing circuit is configured to:
determine whether the WLAN identifier is stored in the database;
if the WLAN identifier is stored in the database, cause the entity not to respond to the message;
if the WLAN identifier is not stored in the database, cause the entity to respond to the message.

30. The entity of claim 28:
further comprising memory configured to store the database;
wherein the processing circuit is configured to cause the WLAN identifier for the device to be stored in the database by causing the WLAN identifier to be stored in the database in the memory.

31. The entity of claim 28:
further comprising a transmitter;
wherein the processing circuit is configured to cause the WLAN identifier associated with the device to be stored in the database by transmitting the WLAN identifier to another entity in the WLAN via the transmitter.

32. The entity of claim 28, wherein the condition comprises a time value, wherein once the time value has expired the WLAN identifier is removed from the database.

33. The entity of claim 32, wherein a speed that the time value is counted down is a predetermined speed.

34. The entity of claim 32, wherein the time value is determined according to:
a measured Received Signal Strength Indicator (RSSI) value of the device during the first association attempt;
an Access Point (AP) cell load;
a load of 3GPP cells which overlap with the AP's area of coverage.

35. The entity of claim 34, wherein a speed that the time value is counted down is dependent upon one or more of:
the measured RSSI value of the device;
a load in the WLAN;
a load on the entity of the WLAN;
the load of 3GPP cells which overlap with the area of the coverage of the entity.

36. The entity of claim 28, wherein the WLAN identifier is the MAC address for the device.
